(19) United States
(12) Patent Application Publication
(10) Pub. No.: US 2009/0024563 A1
(43) Pub. Date: Jan. 22, 2009

(54) METHOD AND SYSTEM FOR ESTIMATING PER QUERY RESOURCE CONSUMPTION

(76) Inventor: Vibhuti Singh Sengar, Unnao (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/778,940

(22) Filed: Jul. 17, 2007

(51) Int. Cl. G06F 17/30

(52) U.S. Cl. 707/2; 707/E17.017

(57) ABSTRACT

There is disclosed a method for estimating query resource consumption for a system storing a representative query resource consumption table. When a query is received, information of a representative query including representative resource consumption information is retrieved from the representative query resource consumption table, where a type of representative query is determined according to the received query. A resource consumption ratio of the received query and the representative query is calculated (computed), and a query resource consumption of the received query is estimated using the representative resource consumption and the calculated resource consumption ratio.

### TECHNICAL FIELD

The present invention relates to storage devices and database systems and in particular to estimation of query resource consumption adoptable for tuning and admission control in database systems.

### BACKGROUND OF THE INVENTION

Tuning and admission control in databases provides a constant challenge to database administrators. Both these issues are complicated due to the complexity and computational overheads involved in measuring the resource consumption of an individual SQL query. The various commercially available Relational Database Management System (RDBMS) usually provides a facility for logging the real-time resource consumption of individual SQL queries but a disadvantage being the large overheads in terms of the RDBMS processing capability, which increase as the granularity of resource consumption information is finer

Further, with increases in complexity and number of structured query language (SQL) queries executed on database servers, it becomes increasingly difficult to estimate the resource requirement and/or consumption of the SQL queries, which for example is required to determine bottleneck queries and SQL admission controls.

An example of a database system which employs SQL query admission controls is the IBM DB2™ query patroller which is typically used in shared database environments, i.e., database systems that are owned/funded by different sets of departments and/or users. A similar system is the quota feature provided by the Unix™ operating system. In general, the query admission controls intercept each query to be received at the database system and estimates the cost in terms of “timerons” (i.e., logical time units) required for the operation. Based on this estimate, the query is either passed to the database system for execution or is disallowed (this functional system is know as an admission control).

A disadvantage with the timeron-based quota allocation approach is that the timerons estimates are logical estimates. That is, the estimates are not given in real time units such as seconds of CPU memory required for execution of the query. As it is hard to determine total logical timeron capacity of a database server machine, the quota allocation based on timeron estimates is inconvenient and error prone. Furthermore, DB2™ query patroller gathers performance data at the resource level (i.e., buffer pool, CPU) and the mechanisms provided for gathering per query resource consumption data that are increasingly resource consuming and provide limited fine granularity.

With respect to database tuning, the most effective approach is to address the SQL statements directly. The best performance gains can normally be achieved by first determining which particular SQL statements are consuming the most system resources, and then determining strategies to reduce such system resource consumption. In a commercial environment, the database servers execute a large number, e.g. thousands, of SQL queries in parallel, and hence estimating or even logging resource consumption, e.g. system resource consumptions, for individual SQL queries is particularly complex and difficult.

Most commercially available RDBMSs provide various types of monitoring techniques for resource consumption. For example the IBM DB2™ database provides a snapshot monitor and event monitors to log the resource consumption of SQL queries. The snapshot monitor is used for low granularity resource consumption monitoring and the event monitor is used for high granularity resource consumption monitoring. However, a disadvantage with the use of high granularity resource monitoring techniques like the event monitor results in large overheads on the database severs thereby deteriorating the overall system performance.

Accordingly, there exists a need to alleviate one or more of the above mentioned disadvantages, provided for with a mechanism and/or processes for estimating the per query resource consumption to reduce the overhead of performing the estimation and/or logging of the individual queries whilst estimating the actual run time with a relatively high accuracy, thereby performing admission controls based on the actual run time estimates in either absolute or percentage values.

### SUMMARY OF THE INVENTION

According to a first aspect of the invention thereof is disclosed a method for estimation of the per query resource consumption from low granularity resource consumption data. An estimate of time required for execution of an SQL query in different system resources for example processor time, random access memory requirements, and also percentage resource consumption by the SQL query is provided to a user. On the basis of the estimate, a user may be able to define quotas based on an actual percentage of resource consumption or absolute value of resource consumption instead of timeron units. An advantage of the actual resource consumption estimate over that of timeron-based units is that, providing percentage resource consumption for a query renders a possibility to estimate resource usage and quotas for a particular user. A further advantage of the percentage resource consumption estimate of for the mechanisms/methods in accordance with this invention may be readily applied to resource allocation for a particular user or operational process than a timeron unit. Further, timeron estimates often do not match with actual run time resource consumption and therefore resource allocation based on run time estimates rather than timeron estimates is a rather significant advantage.

The aggregate resource consumption of a group of queries (in a given execution interval) is subdivided into resource consumption of each individual query. To achieve this, the resource requirements of SQL queries are expressed in relative forms with respect to a representative query, and using that representative query, the aggregate consumption of a group of queries in certain execution interval is subdivided. It is not necessary to directly measure resource consumption/requirement of individual queries, but they are obtained subdividing the aggregate consumption. Since measuring resource consumption for an execution interval in terms of physical values (10 sec CPU) or percentage values(50% of CPU) consumes less time, the method in accordance with this invention advantageously subdivides and provides them at individual query level. The terms “resource consumption” and “resource requirement” refer to the amount of resource that will be engaged or is engaged in query execution. The terms “fine granularity” and “high granularity” refer to enhanced subdivided (per resource, per disk, per query) information.

According to a second aspect of the invention thereof is disclosed a method for estimating query resource consumption for a system storing a representative query resource consumption table. When a query is received, information of a representative query including representative resource consumption information is retrieved from the representative query resource consumption table, where a type of representative query is determined according to the received query. A resource consumption ratio of the received query and the representative query is calculated (computed), and a query resource consumption of the received query is estimated using the representative resource consumption and the calculated resource consumption ratio.

According to a third aspect of the invention thereof is also disclosed a query resource consumption estimation system for estimating resource consumption for executing a query. The system comprises an interface for receiving a query for resource consumption estimation, a storage device and a processor. The storage device stores a representative query resource consumption table including information of a plurality of representative queries each of a query plan with corresponding representative resource consumption information. The processor retrieves information of a representative query from the representative query resource consumption table where a type of the representative query is determined according to the received query, calculating (computing) a resource consumption ratio of the received query and said representative query, and estimating a query resource consumption of the received query using the representative resource consumption and the calculated (computed) resource consumption ratio.

According to a fourth aspect of the invention thereof is also disclosed a computer program product having a computer readable medium having a computer program recorded therein for query resource consumption estimation program for a system having a storage device for storing at a representative query resource consumption table. The computer program comprises computer program code means for receiving a query and computer program code means for retrieving information of a representative query including representative resource consumption information from said representative query resource consumption table, where a type of said representative query is determined according to said input (received) query. The computer program further comprises computer program code means for calculating (computing), by said processor, a resource consumption ratio of said input (received) query and said representative query; and computer program code means for estimating a query resource consumption of said input (received) query using said representative resource consumption and said calculated resource consumption ratio.

According to a fifth aspect of the invention thereof is disclosed a computer data signal operable to cause a computer to execute a process for estimating query resource consumption using a representative query resource consumption table. The process comprises receiving a query and retrieving information of a representative query including representative resource consumption information from said representative query resource consumption table, where a type of said representative query is determined according to said received query. The process further comprises calculating a resource consumption ratio of said received query and said representative query and estimating a query resource consumption of said received query using the representative resource consumption and said calculated resource consumption ratio.

### BRIEF DESCRIPTION OF THE DRAWINGS

A preferred embodiment of the present invention will now be described, by way of an example only, with reference to the accompanying drawings wherein:

FIG. 1 is a schematic block diagram of the computer platform;

FIG. 2 is a detailed scheme of the computer module performing query resource consumption estimation;

FIG. 3 is a schematic structure of a representative query resource consumption table;

FIG. 4 is a schematic structure of a history performance data table;

FIG. 5 is a flowchart of a query resource consumption estimation process;

FIG. 6 is a flowchart of representative query resource consumption calculation; and

FIG. 7 is an example of a query.

### DETAILED DESCRIPTION OF THE PREFERRED EMBODIMENTS

### Computer Platform

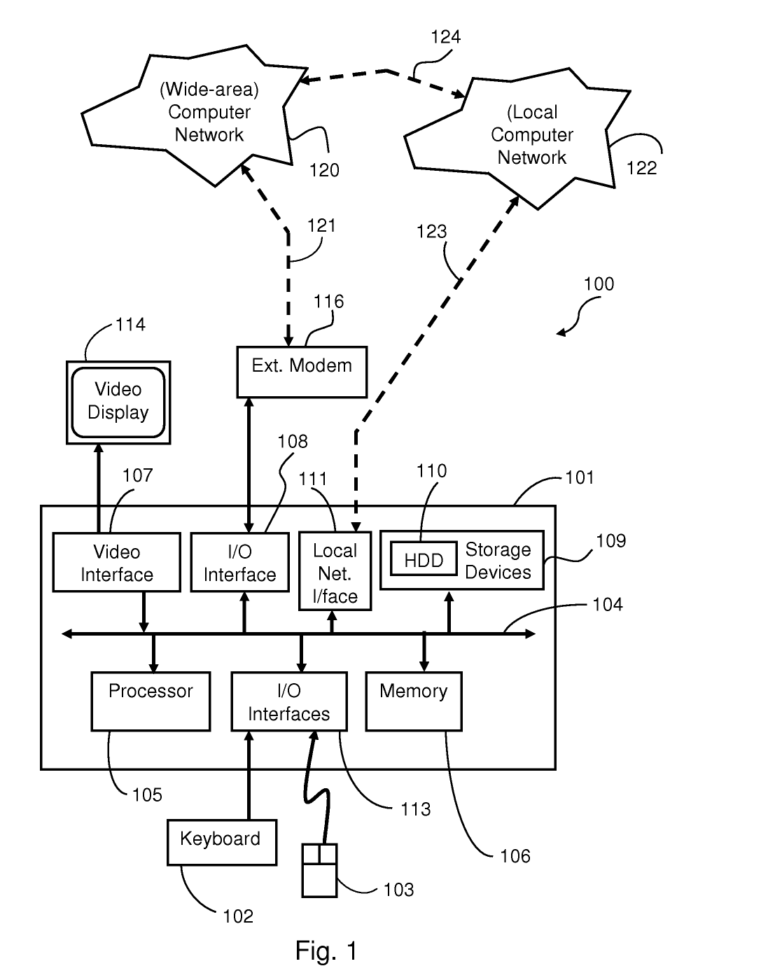

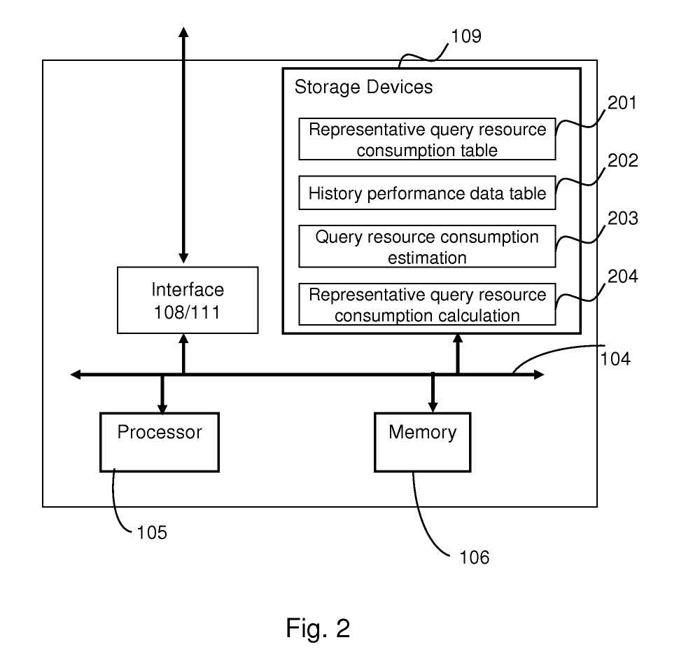

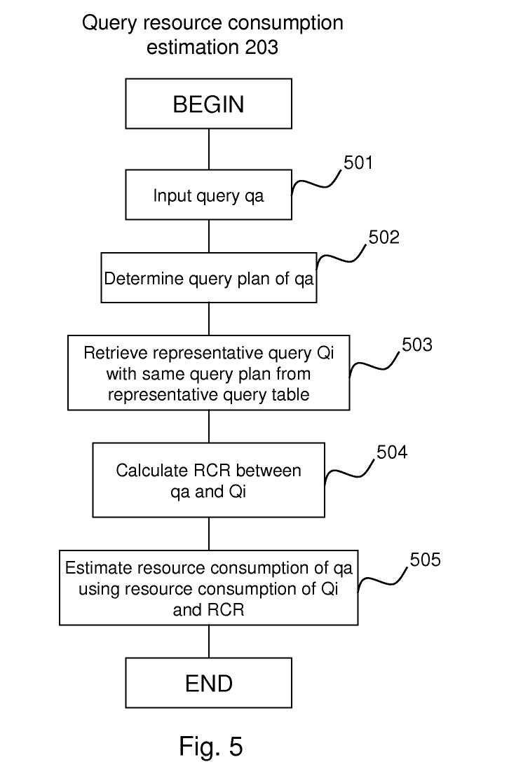

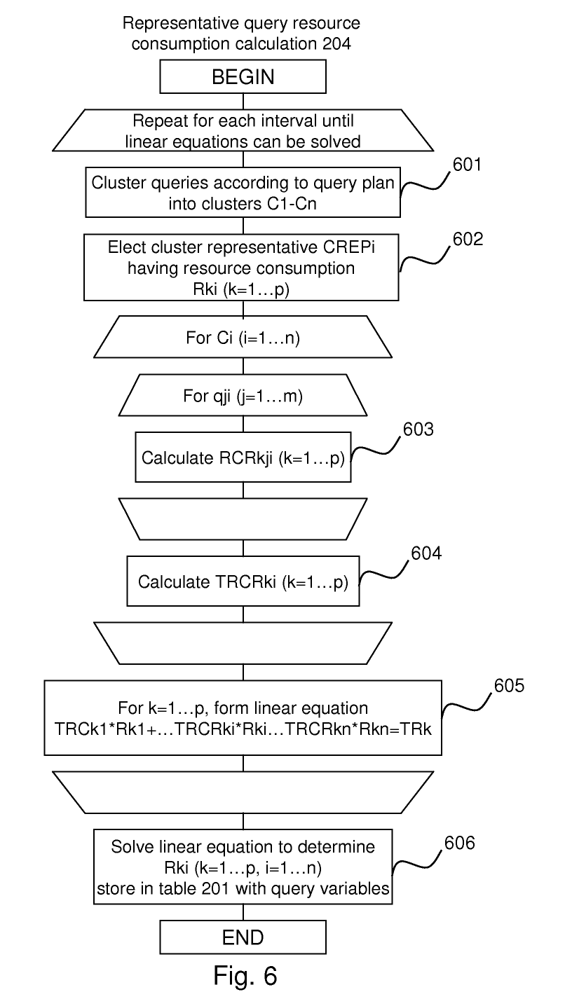

Referring to the drawings, FIG. 1 shows a schematic block diagram of a general purpose computer system (100) with which arrangements described below using FIGS. 2 to 6 can be implemented. The processes of FIGS. 5 and 6 may be implemented as software, such as one or more application programs executable within the computer system 100. The instructions may be formed as one or more code modules, each arranged for performing one or more particular tasks. The software may also be preferably divided into three separate parts, in which a first part and the corresponding code modules performs the query resource consumption estimation, the second part of the corresponding code modules performs the representative query resource consumption calculation and a third part of the corresponding code modules manages a user interface or the inter-device interface used for such tasks as receiving queries or logging queries and their resource consumption. The software may be stored in a computer readable medium, including the storage devices described below, for example. The software is loaded into the computer system 100 from the computer readable medium, and then executed by the computer system 100. A computer readable medium having such software or computer program recorded on it is a computer program product.

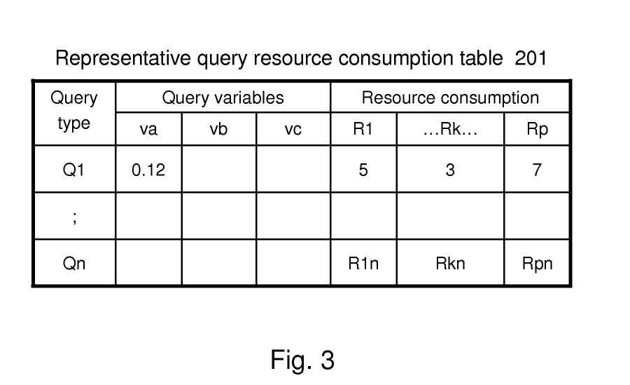

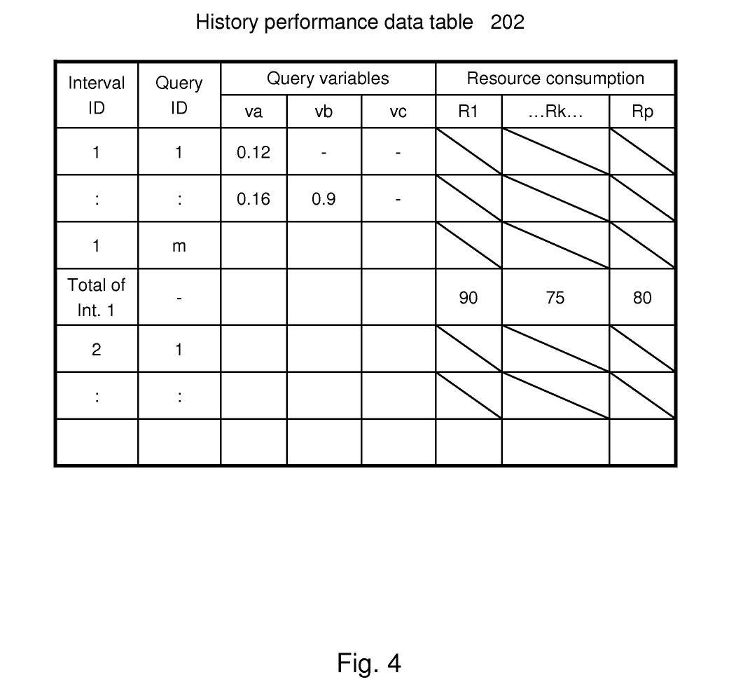

As seen in FIG. 1, the computer system 100 is formed by a computer module 101, input devices such as a keyboard 102 and a mouse pointer device 103, and output device may be a display device 114. The computer system 100 for the query execution may be constructed such that the database system for executing queries is accessible via a network by a user terminal for entering queries and outputting the query results. Each of the processes of FIGS. 5 and 6 and the tables shown in FIGS. 3 and 4 may be implemented in the database system or the user terminal, or in a separate server which is connected to the database system and the user terminal via a network. Here, for ease of understanding, a database system—user terminal—server configuration example where the server is shown in FIG. 1 as the computer module 101 is used for the following description.

An external Modulator-Demodulator (Modem) transceiver device 116 may be used by the computer module 101 for communicating to and from a communications network 120 via a connection 121. The network 120 may be a wide-area network (WAN), such as the Internet or a private WAN.

The computer module 101 typically includes at least one processor unit 105, and a memory unit 106 for example formed from semiconductor random access memory (RAM) and read only memory (ROM). The module 101 also includes an number of input/output (I/O) interfaces including an video interface 107 that couples to the video display 114, an I/O interface 113 for such devices like the keyboard 102 and mouse 103, and an interface 108 for the external modem 116. In some implementations, the modem 116 may be incorporated within the computer module 101, for example within the interface 108. The computer module 101 may also have a local network interface 111 which, via a connection 123, permits coupling of the computer system 100 to a local computer network 122, known as a Local Area Network (LAN). As also illustrated, the local network 122 may also couple to the wide network 120 via a connection 124, which would typically include a so-called “firewall” device or similar functionality. The interface 111 may be formed by an Ethernet™ circuit card, a wireless Bluetooth™ or an IEEE 802.11 wireless arrangement.

Storage devices 109 are provided and typically include a hard disk drive (HDD) 110. It should be apparent to a person skilled in the art that other devices such as a floppy disk drive, an optical disk drive and a magnetic tape drive (not illustrated) etc., may also be used and fall within the scope of this invention. The components 105 to 113 of the computer module 101 typically communicate via an interconnected bus 104 and in a manner which results in a conventional mode of operation of the computer system 100 known to those in the relevant art.

Typically, the application programs discussed above are resident on the hard disk drive 110 and read and controlled in execution by the processor 105. Commands for executing the application program in the form of a computer data signal from the storage device 109 can be executed on the processor 105. Alternatively, the computer data signal including the commands may be generated from the client for generating queries and transmitted over a network to be executed on the processor 105. Storage of intermediate products from the execution of such programs may be accomplished using the semiconductor memory 106, possibly in concert with the hard disk drive 110. In some instances, the application programs may be provided to the user encoded on one or more CD-ROM or other forms of computer readable media and read via the corresponding drive, or alternatively may be read by the user from the networks 120 or 122.

The third part of the application programs and the corresponding code modules mentioned above may be executed to implement one or more graphical user interfaces (GUIs) to be rendered or otherwise represented upon the display 114 or to implement other modes of input/output or storage control. Through manipulation of the keyboard 102 and the mouse 103, a user of the computer system 100 and the application may manipulate the interface to provide commands and/or input controlling the applications associated with the GUI(s).

### Normalized Expression of Query Resource Consumption

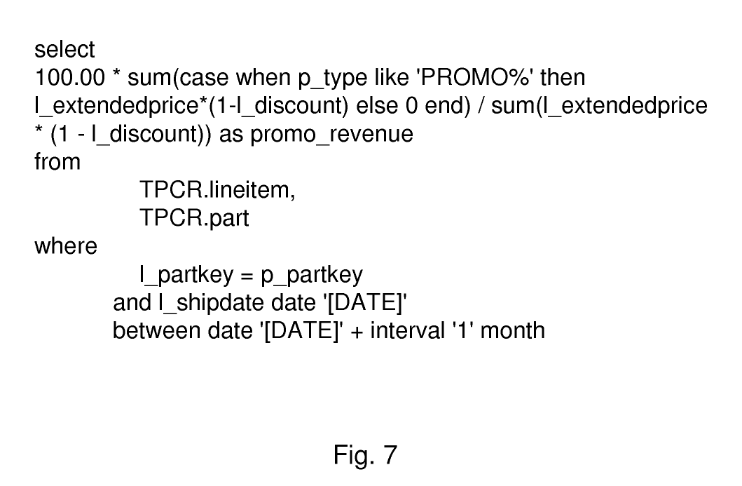

The resource requirement/consumption of a query can be expressed in terms of resource consumption of another query provided the two queries have the same query plan tree. If two queries have the same query plan (query plan tree), the difference in bind variables or selectivity of the select predicate (collectively called query variables hereinafter) can be used in order to compensate for the difference in resource consumption of the two queries. A method for generating a normalized expression of query resource consumption is described using an example query Q14 or the TPC-R benchmark, shown in FIG. 7.

FIG. 7 illustrates two queries q1 and q2 preferably having the same query plan and a differing bind value. Suppose the query q1 has 1_shipdate predicate selectivity 0.12 and consumes R1 (lineitem buffer pool), R2 (part buffer pool), R3 (CPU) resources, and the query q2 has 1_shipdate predicate selectivity 0.16 and consumes R1′ (lineitem buffer pool), R2′ (part buffer pool), R3′ (CPU) resources. The function for calculating the resource consumption ratio (RCR) depends upon the query operator (i.e., NL, Merge, index scan) and selectivity of select conditions of both queries. An RCR calculation function exists for each query operator (i.e., NL, Merge, index scan). The logic associated with the RCR calculation for individual query operator can be extended to the full query plan level RCR calculation logic. The RCR is considered to be a ratio of input to the query operators which is the ratio of selectivity of select condition that affects input size. However, an improved logic for RCR calculation with better accuracy and efficiency can be defined by a user When all other parameters other than the predicate selectivity are equal, the resource consumption ratio (RCR) of the query q2 to the query q1 is 0.16/0.12=1.33. The resource consumption (R1′, R2′ and R3′) of the query q2 can be expressed in terms of R1, R2 & R3 where in this case R1′=1.33R1, R2′=1.33R2, and R3′=1.33R3. Therefore, the resource consumption of one query can be expressed in terms of resource consumption of another query with the same query plan. The SQL query plan is generally a tree composed of query execution operators (i.e. nested loop). If the resource consumption of another query with the same query plan is known, then the resource consumption of a given query can be estimated using the known resource consumption and the RCR.

In general, the function for calculating (computing) the resource consumption ratio (RCR) depends on parameters such as query operator, size of input relations, selectivity of select conditions of the queries etc. For better accuracy, a RCR calculation function for each query operator (i.e., NL, Merge, index scan) is computed. However, in most of the practical query operators, the RCR is considered to be a ratio of input to the operators, which in common case approximately equals the ratio of size of input relations and selectivity of select conditions that affects input size. Other RCR functions for specific operators may also be used to enhance accuracy and efficiency.

Since query plans of complicated SQL queries typically consist of more than one operator, there exist multiple RCRs for a given query. In such cases, a single RCR can be extended to multiple RCR by calculating (computing) RCR for each query operator inside the query plan of the individual queries. In the example discussed previously, all factors other than the predicate selectivity being equal, the resource consumption ratio (RCR) of join operator between part and lineitem of the query q2 to the query q1 is 0.16/0.12=1.33. The resource consumption (R1′, R2′ and R3′) of the query q2 can be expressed in terms of R1, R2 & R3 as: R1′=1.33R1, R2′=1.33R2 and R3′=1.33R3.

The resource consumption of a query operator depends upon size of input relations, selectivity of select and join conditions, and system parameters (e.g. memory). Assuming that system parameters do not change substantially across execution of two queries having the same query plan, the resource consumption of an operator will change only based upon size of its input relations (or selectivity of select conditions on the relation). Therefore, the resource consumption ratio (RCR) of a query operator in two different queries having same query plan will generally depend upon input relation size and relation selectivity. For most of the query operators, ratio of resource consumption (cost) is close to ratio of the input relation size, so for most of query operators, RCA can be assumed to be equal to the ratio of input relation size (note, for some operators, RCA can be one as well). Different commercial databases using different types of query operators (e.g. nested loop, blocked nested loop, merge join, index scan) to execute SQL queries may require different RCA.

RCA for nested loop join operator is derived as follows. In a query qa, nested loop join operator joins relation Rel1 (having n1 tuples) and relation Rel2 (having n2 tuples), the cost of operator is n1*n2*C, where the constant C depends upon system parameters. In another query qb, having same query plan as the query qa, the nested loop operator joins relation Rel1′ (having n1′ tuples) and the relation Rel2′ (having n2′ tuples), the cost of execution will be n1′*n2′*C. The ratio of cost between the query qa and query qb is (n1′*n2′*C)/(n1*n2*C), which is approximately the ratio of the input relations.

### Query Resource Consumption Estimation and History Performance Data Analysis

FIG. 2 shows a detailed scheme of the computer module (server) 101 in the database system—user terminal—server configuration example in accordance with the present invention. The modules with same reference numbers as used in FIG. 1 represent the modules as described referring to FIG. 1. For simplicity, FIG. 2 only shows the hardware modules which have functions pertaining to the present invention. Tables for storing representative query resource consumption 201 and history performance data of past queries 202 are preferably stored in the storage device 109. Programs for query resource consumption estimation 203 and representative query resource consumption calculation 204 are stored in the storage device 109 and are executed by the processor 105. The query resource consumption estimation 203 is executed using the representative query resource consumption table 201. Prior to the execution of query resource consumption estimation 203, representative query resource consumption calculation 204 is executed using the history performance data table 202 to prepare the representative query resource consumption table 201.

FIG. 3 shows a schematic structure of the representative query resource consumption table 201. The representative query resource consumption table 201 stores representative resource consumption for each type of queries. Query types are defined according to query plans of the queries, and queries having the same query plan will be of the same query type and vice-versa. The method for generating a query plan from a query text is well known in the art. The resource consumption is measured, as an example, in percentage of the total capacity of each resource being put to use in a particular time interval. For example, in the first entry of the representative query resource consumption table 201 is the information that a query of the query type Q1 with the variable va_selectivity=0.12 would take up 5%, 3% and 7% of the total capacity of the resources R1, Rk and Rp, respectively. The representative query resource consumption table 210 is prepared in advance to serve as a reference for estimating the resource consumption of an incoming query with yet unknown resource consumption.

FIG. 5 shows a flowchart of the query resource consumption estimation 203 process, for estimating the resource consumption of an incoming query based on the representative query resource consumption data of the same query plan and the RCR of the incoming query to the representative query. The processor 105 executes the query resource consumption estimation 203 referring to the representative query resource consumption table 201 and outputs the query resource consumption estimation results.

In step 501, a query Qa for which an estimation is to be performed is input through either one of the interfaces. In the case of the database system—user terminal—server configuration, the I/O interface 108/111 receives the query Qa to be processed by the processor 105. In step 502, the processor determines the query plan of the query Qa. In step 503, the representative query Qi having the query plan which is the same as that of the query Qa is retrieved from the representative query resource consumption table 202. In step 504, the processor 105 calculates the RCR of the query Qa to the representative query Qi based on their properties such as the bind variables or the predicate selectivity. In step 505, the processor estimates the resource consumption of the query Qa based on the resource consumption of the representative query Qi and the calculated RCR, using Equation 1:

RkQa=RCR*RkQi. (Equation 1)

where, RkQa is the estimated resource consumption by the query Qa for the resource Rk and the RkQi is the resource consumption by the representative query Qi for the resource Rk, as retrieved from the representative query resource consumption table 201.

By executing the steps shown in FIG. 5, when the resource consumption is known for a representative query having a certain query plan, the resource consumption of another query having the same query plan can be estimated based on the RCR.

Next, the process for preparing the representative query resource consumption table 201 will be described referring to FIGS. 3, 4 and 6. The process of FIG. 6 is executed in order to prepare the representative query resource consumption table 201 to be used for the estimation of resource consumption of new incoming queries.

FIG. 4 shows a schematic structure of the history performance data table 202. The contents of the history performance data table 202 are collected by monitoring queries executed in parallel in each set intervals and the total resource consumption for the corresponding interval. The monitoring can be performed by the database system and then the entire history performance data table 202 can be transmitted to the computer module 101, including also the measured resource consumption. Alternatively, the monitoring can be performed by the computer module 101 to obtain and store the individual query details including query variables and then the total resource consumption data can be supplied from the database system to complete the history performance data table 202.

FIG. 6 illustrates a process to estimate the resource consumption of an individual query of each type of query plans based on the total resource consumption of the database system. When considering a certain interval of queries execution, it becomes rather expensive to measure the resource consumption of each query for the overhead. The total resource consumption of all the queries executed in parallel during an interval is therefore measured and stored in the history performance data table 202 which can be advantageously used in estimating resource consumption. In an alternate embodiment, as the detailed information of the individual queries and the total resource consumption are obtained separately, the information can be stored in separate tables.

The concept of normalizing the resource consumption of queries of the same query plan in terms of the resource consumption of a representative query is further detailed. Reference is made now to the query Q14 of the TPC-R benchmark shown in FIG. 7. Suppose, in a defined interval, the database server executed only queries Q1 and Q2 having predicate selectivities 0.12 and 0.16 respectively, and the resulting RCR being 1.33, the relationship of the query resource consumption of the two queries Q1 and Q2 (R and R′, still unknown) and the total resource consumption (RT) can be expressed in the following linear equations (Equation 2).

R1+R1′=RT1—lineitem table bufferpool consumption

R2+R2′=RT2—part table bufferpool consumption

R3+R3′=RT3—CPU consumption (Equation 2)

Note RT1, RT2 and RT3 are available in the snapshot monitor data of the database system, and RCR (1.33) is calculated using the RCR function. The above linear equations can be rewritten as Equation 3:

R1+R1*1.33=RT1

R2+R2*1.33=RT2

R3+R3*1.33=RT3. (Equation 3)

Solving these equations,

R1=RT1/2.33, R2=RT2/2.33, R3=RT3/2.33

R1′=RT1 (1.33/2.33), R2′=RT2 (1.33/2.33), R3′=RT3 (1.33/2.33) (Equation 4)

and the resource consumption of the individual queries q1 and q2 can be computed. This is the basic concept of normalization of query resource consumption, i.e., forming linear equations of resource consumption and solving the equations for individual query resource consumption. Here, the query Q1 was selected as the “representative query”, and for the purpose of obtaining the representative query resource consumption table 201, only the resource consumption of the representative query (R) needs to be calculated from aggregate history performance data. This data is obtained by subdivision of the aggregate consumption data.

In this case, only one query plan was used to execute two different queries, therefore only one time interval data (one linear equation for each resource) was required. In general, the number of data samples/linear equations required is always bounded by number of distinct query plans used for execution.

FIG. 6 shows a flowchart of the representative query resource consumption calculation 204, expanding the previously described linear equations with reference to the database system (not defined) that executes queries of different query plans in parallel in given intervals. The processor 105 executes the representative query resource consumption calculation program 204 referring to the history performance data table 202 and outputs the calculation results to the representative query resource consumption table 201.

In the process of FIG. 6, one linear equation for each resource involved is generated for each interval, and the final output of the process is the resource consumption by each type of queries for each resource Rki (k=1 . . . p, i=. . . n) where p is the number of resources involved (such as the bufferpool and CPU) and n is the number of types of queries.

Steps 601 to 605 are performed for each time interval of the query records in the history performance data table 202 until there are sufficient linear equations formed in order to solve for all of Rki (k=1 . . . p, i=1 . . . n) where for n types of query plans, at least n linear equations (n time interval data) are required for each resource.

In step 601, query plans are generated for the queries executed in the same time interval as stored in the history performance data table 202. The queries are then clustered into clusters Ci (i=1 . . . n) for query types Qi (i=1 . . . n) according to the query plans. In step 602, a cluster representative query CREPi having resource consumption variables Rki (k=1 . . . p) is elected for each cluster as the reference for normalization. As the representative query is important for computing the RCR, the representative query can be selected from the actual queries found in the history performance data table 202, or, alternatively, a hypothetical query of the same query plan having arbitrary query variables can be created for the purpose. The cluster representatives remain the same across all time intervals.

Steps 603 and 604 are performed for each of the clusters Ci (i=1 . . . n). In step 603, for each query qji (j=1 . . . m) where there are m queries in the cluster Ci, the resource consumption ratio RCRkji with respect to the cluster representative CREPi query resource consumption Rki is calculated. When RCRkji for all the queries in the cluster have been calculated, the total RCR (TRCRki, k=1 . . . p) for the queries in the cluster Ci are calculated according to Equation 4 and stored in the working memory in step 604.

TRCRki=sum(RCRkli . . . RCRkji . . . RCRkmi) (Equation 4)

In step 605, the following linear equation (Equation 5) is formed for each TRk (k=1 . . . p) where TRk is the total resource consumption of resource k in the given interval.

(TRCRkl*Rkl+ . . . +TRCRki*Rki+ . . . TRCRkn*Rkn)=TRk (Equation 5)

In the next time interval, the steps 601 to 605 are repeated. Steps 601 to 605 are repeated until a sufficient number of linear equations to solve to obtain values of all Rki (k=1 . . . p, i=1 . . . n) are obtained. In step 606, the linear equations are solved and the results Rki (k=1 . . . p, i=1 . . . n) are stored in the representative query resource consumption table 201 together with the query type and the query variables corresponding to the respective cluster representative query CREPi.

Once the resource requirement R1i . . . Rpi for cluster representative query CREPi of the query type Qi is stored in the representative query resource consumption table, the resource requirement of an incoming query that uses the same query plan as cluster representative query Ci can be easily calculated by the method described previously, i.e. calculating RCRs of incoming query with respect to cluster representative query CREPi.

According to this embodiment, the RCR calculation is performed using simple mathematical function using query variables and the resource consumption of the corresponding query type calculated and stored in advance as representative query resource consumption. As the resource consumption estimation process can be performed by looking up the table of the representative query resource consumption table 201 and relatively simple calculations, the method advantageously uses lesser overhead for the database system. Also, as the representative query resource consumption is prepared using actual measured resource consumption, the output of the resource consumption estimation can be made in a form that is more readily applicable for resource allocation or admission control than timeron-based resource consumption estimation. With regards to the query resource consumption calculation using history performance data, representing resource requirement of different queries, having same plan, in terms of a single query (cluster representative query) resource requirement, reduces the number of variables in linear equations, and hence minimizes requirement of the history performance data.

While the above embodiment is based on the database system - user terminal - server configuration with all tables and programs/processes of the invention implemented in the server, various other configurations are also possible. For example, the representative query resource consumption calculation 204 can be performed by the database system, the resultant table 201 notified to and stored at the server or stored at the database system and referred to by the server for the execution of query resource consumption estimation 203. The history performance data table 202 can be stored in the database system to be referred to by the apparatus executing the representative query resource consumption calculation 204. The above described functions of the server can be in their entirety included in the database system or built into a resource allocation or admission control server. It is also possible to implement the query resource consumption estimation process 203 into the user terminal to be executed referring to the representative query resource consumption table 201 notified to the user terminal in advance or stored in the server or the database system to be accessed as necessary.

The system and the method described herein, and/or shown in the drawings, are presented by way of example only and are not limiting as to the scope of the invention. Unless otherwise specifically stated, individual aspects and components of the system and the method may be modified, or may have been substituted therefore by equivalent means. The system and method may also be modified for a variety of applications while remaining within the scope and spirit of the claimed invention, and be adaptable to variations which fall within the scope of this invention.

We claim:

1. A method for estimating query resource consumption for a system storing a representative query resource consumption table, the method comprising:
receiving a query;
retrieving information of a representative query including representative resource consumption information from said representative query resource consumption table, wherein a type of said representative query is determined according to said received query;
calculating a resource consumption ratio of said received query and said representative query; and
estimating a query resource consumption of said received query using the representative resource consumption and said calculated resource consumption ratio.

2. The method of claim 1, further comprises
determining a query plan for the received query, wherein said type of said representative query to be retrieved from said representative query resource consumption table is determined based on a query plan of said representative query being the same as that of said received query.

3. The method of claim 1, wherein the information of a representative query further includes representative query variables, and said resource consumption ratio of said received query and said representative query is calculated based on received query variables of said received query and said representative query variables.

4. The method of claim 1, further comprising:
calculating said representative query resource consumption using history performance data including a plurality of past query data each having query variables of queries executed in set time interval and a total resource consumption for said set time interval; and
storing said calculated representative query resource consumption in said representative query resource consumption table in a storage medium.

5. The method of claim 4, further comprising:
expressing past query resource consumption of said queries of a same query plan as said representative query, and executed in said set time interval in terms of said representative query resource consumption; and
calculating the representative query resource consumption by inclusion of the total resource consumption.

6. The method of claim 5, wherein there exist past queries for a plurality of query plans, further comprises clustering said past query data into a plurality of clusters according to their query plans,
wherein said steps of expressing past query resource consumption of said queries of a same query plan as said representative query, and executed in said set time interval in terms of said representative query resource consumption and calculating said representative query resource consumption are repeated for a plurality of time intervals to obtain said representative query resource consumption for each of said plurality of query plans.

7. A query resource consumption estimation system for estimating resource consumption for executing a query, comprising:
an interface for receiving a query for resource consumption estimation;
a storage medium for storing a representative query resource consumption table including information of a plurality of representative queries each of a query plan with corresponding representative resource consumption information; and
a processor for retrieving information of a representative query from said representative query resource consumption table wherein a type of said representative query is determined according to said received query, calculating a resource consumption ratio of said received query and said representative query, and estimating a query resource consumption of said received query using said representative resource consumption and said calculated resource consumption ratio.

8. The system of claim 7, wherein said processor further determines a query plan of said received query, wherein said type of said representative query to be retrieved from said representative query resource consumption table is determined based on a query plan of said representative query being the same as that of said received query.

9. The system of claim 7, wherein said information of a representative query further includes representative query variables, and said processor calculates said resource consumption ratio of said received query and said representative query based on received query variables of said received query and said representative query variables.

10. The system of claim 7, wherein said processor further calculates said representative query resource consumption using history performance data including a plurality of past query data each having query variables of queries executed in set time interval and a total resource consumption for said set time interval, and stores said calculated representative query resource consumption in said representative query resource consumption table in said storage medium.

11. The system of claim 10, wherein said processor further performs the steps of:
expressing past query resource consumption of said queries of a same query plan as said representative query, and executed in said set time interval in terms of said representative query resource consumption; and
calculating said representative query resource consumption by inclusion of the total resource consumption.

12. The system of claim 11, wherein there exist past queries of a plurality of query plans, and said processor further performs the step of clustering said past query data into a plurality of clusters according to their query plans,
wherein said steps of expressing past query resource consumption of said queries of a same query plan as said representative query, and executed in said set time interval in terms of said representative query resource consumption and calculating said representative query resource consumption are repeated for a plurality of time intervals to obtain said representative query resource consumption for each of said plurality of query plans.

13. A computer data signal operable to cause a computer to execute a process for estimating query resource consumption in an enterprise system using a representative query resource consumption table, the process comprising:
receiving a query;
retrieving information of a representative query including representative resource consumption information from said representative query resource consumption table, wherein a type of said representative query is determined according to said received query;
calculating a resource consumption ratio of said received query and said representative query; and
estimating a query resource consumption of said received query using the representative resource consumption and said calculated resource consumption ratio.

14. The computer signal of claim 13, said process further comprises
determining a query plan for the received query, wherein said type of said representative query to be retrieved from said representative query resource consumption table is determined based on a query plan of said representative query being the same as that of said received query.

15. The computer signal of claim 13, wherein the information of a representative query further includes representative query variables, and said resource consumption ratio of said received query and said representative query is calculated based on received query variables of said received query and said representative query variables.

16. The computer signal of claim 13, said process further comprising:
calculating said representative query resource consumption using history performance data including a plurality of past query data each having query variables of queries executed in set time interval and a total resource consumption for said set time interval; and
storing said calculated representative query resource consumption in said representative query resource consumption table in a storage medium.

17. The computer signal of claim 16, said process further comprising:
expressing past query resource consumption of said queries of a same query plan as said representative query, and executed in said set time interval in terms of said representative query resource consumption; and
calculating the representative query resource consumption by inclusion of the total resource consumption.

18. The computer signal of claim 17, wherein there exist past queries for a plurality of query plans, said processing further comprises clustering said past query data into a plurality of clusters according to their query plans,
wherein said steps of expressing past query resource consumption of said queries of a same query plan as said representative query, and executed in said set time interval in terms of said representative query resource consumption and calculating said representative query resource consumption are repeated for a plurality of time intervals to obtain said representative query resource consumption for each of said plurality of query plans.

19. The computer signal of claim 13, wherein said computer signal is generated from a client and transmitted over a network to be executed on the enterprise system.

20. A computer program product having a computer readable medium having a computer program recorded therein for query resource consumption estimation program for a system having a storage medium for storing at a representative query resource consumption table, capable of performing a method comprising:
receiving a query;
retrieving information of a representative query including representative resource consumption information from said representative query resource consumption table, wherein a type of said representative query is determined according to said received query;
calculating a resource consumption ratio of said received query and said representative query; and
estimating a query resource consumption of said received query using the representative resource consumption and said calculated resource consumption ratio.
